(19) United States
(12) Patent Application Publication
(10) Pub. No.: US 2003/0132731 A1
(43) Pub. Date: Jul. 17, 2003

(54) Contactless battery charging device

(75) Inventor: Geng-horng Chung, Taipei (TW)

Correspondence Address: BACON & THOMAS, PLLC, 625 SLATERS LANE, FOURTH FLOOR, ALEXANDRIA, VA, 22314

(73) Assignee: ASOKA INC., Taipei (TW)

(21) Appl. No.: 10/043,129

(22) Filed: Jan. 14, 2002

(51) Int. Cl. H02J 7/00

(52) U.S. Cl. 320/108

(57) ABSTRACT

This creation is a “contactless charging device” with regard to a new contactless type and is applicable to the chargers for packaging and rechargeable batteries. The charger in itself is equipped with an ultrasound waves oscillator, in which the circuits is made output to an emission resonator to produce a powerful magnetic field and to radiate to the surrounding area of the charger. Moreover, within the battery packet charged is installed a receiving oscillator. The two sets of the oscillators resonate and induce the powerful magnetic field in the surrounding area of the charger and then a conversion is made into voltage and current, which are directly charged into the battery body in the battery packet. In this way, a charging effect is completed.

### BACKGROUND OF THE INVENTION

1. Field of the Invention

A charging means that does not require a contact between contacts but still can charge and can provide the charging for general batteries with great convenience.

2. Description of the Related Art

The conventional battery charging type of chargers is a type of batteries which has exposed contacts on both ends (charger and batteries) of metal contact. And the metal pieces are used to conduct current. When the metal pieces are used to contact each other, the aforementioned structure will frequently result in a poor contact or a half-contact condition. If the effect of the metal piece is not sufficient or the position is deviated, among other factors, the charging will become incomplete, or due to the carbonization of the contacts and thus the production of heat, the result becomes a waste of electricity. As a result, the conventional charging type of chargers is still a obstacle in use and produces a lot of waste, resulting in a discount in charging effect.

### SUMMARY OF THE INVENTION

Utilizing a powerful ultrasound field produced on a charger through the radiation of a resonator on the surrounding area of a charger, and on the resonance inducing field of the resonator on a battery packet to convert into voltage and electricity, which are directly charged into the battery to complete a contactless “aerial charging,” is the major objective of this invention.

### BRIEF DESCRIPTION OF THE DRAWINGS

FIG. 1, a representation of the device of this invention.

FIG. 2, a diagram of the output of the oscillator within the charger of this invention to a transmitting resonator.

FIG. 3, a diagram of the rectifying circuit receiving a resonator within the battery packet of this invention.

FIG. 4, a diagram of resonating of resonators of this invention.

### DETAILED DESCRIPTION OF THE PERFERRED EMBODIMENT

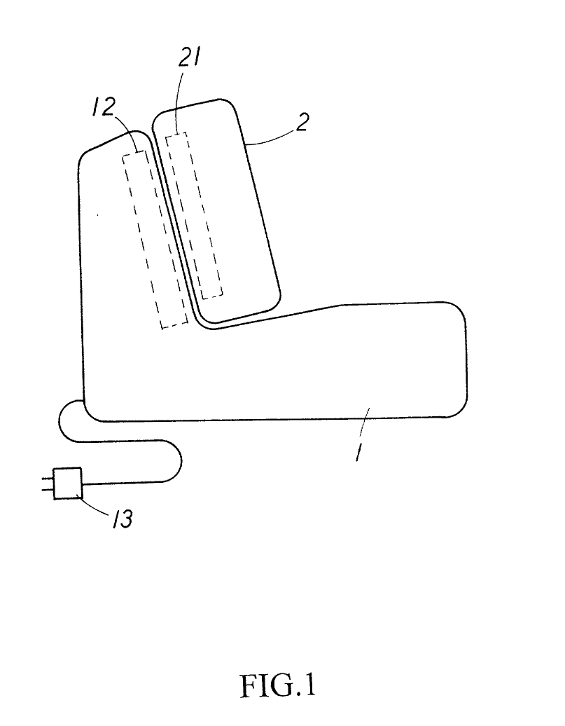

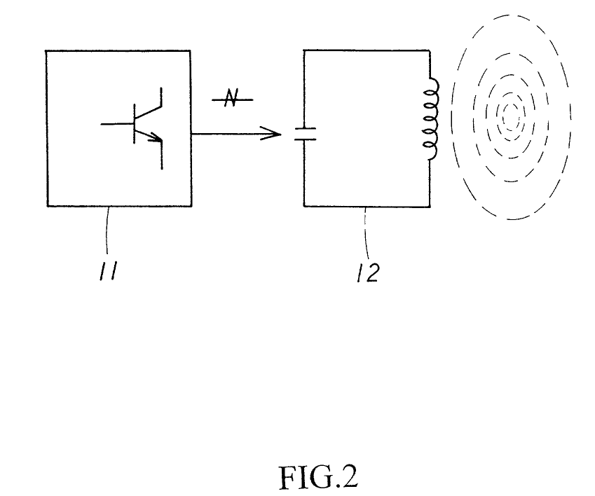

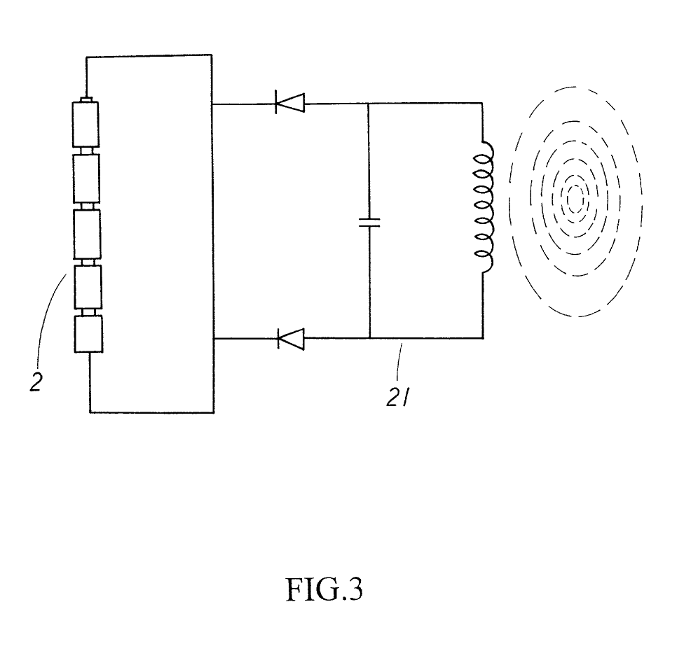

Refer to FIGS. 1, 2, 3 and 4, in which the charger (1) is provided with a power line (13) and can provide a charging pattern. In the inside are installed an ultra-sound oscillatory (11) and an emission resonators (12) and on its surface forms a loading area for the battery packet;

The battery packet (2) is a battery pattern within which is installed with a receiving resonator (21);

From the above-mentioned, when used, the charger (1) will provide a charging status with a power line (13) in advance and the emission resonator (12) will radiate the ultrasound waves from the ultrasound oscillator (11) on the periphery of the charger (1). Place the rechargeable battery packet (2) on the peripheral area of the charger (1) and the receiving resonator (21) on the battery packet (2) will produce a resonating effect, inducing the powerful magnetic waves on the periphery of the charger (1) that it converts into voltages and currents, which through a set of rectifying current, are charged into the battery packet (2) after being rectified and then a reliable and true charging process is completed.

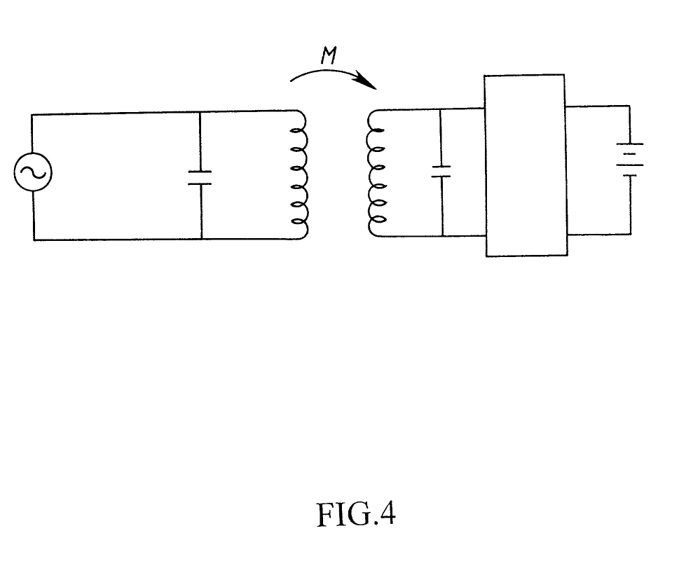

The transfer of the energy of the magnetic waves between the battery packet (2) and the charger (1) is proceeded by Using a resonating inducing means. The magnetic field radiated by the transmitting resonator (2) in the charger (1), because the resonating effect induces the receiving resonator of the battery packet (2), thus converts into voltage and current, which, after being rectified, are charged into the battery packet (2) and complete the charging, in which two sets of the emission resonators (12) and a receiving resonator (21), through the effect of the transfer of energy of the resonating induction in the field, are acting like the interconnection effect of the coils on an electronic line. Refer to FIG. 4.

That is, it's a charging device without the contact between contacts The greatest benefit is that a complete charging can be assured, avoiding the contact of contacts and a poor assembly and thus resulting in an inconspicuous charging effect. Consequenltly, the device of this invention can be applied to the charging of the ordinary wireless telephones in the house, the charging of mobile phones, as well as rechargeable battery merchandizes.

To sum up the above, in addition to avoiding the contact of the metal pieces of the charger, the device provided, because the principal of the resonating induction of a field effect for the energy transfer, can avoid defects such as an unreliable contact and carbonization. The invention, which combines each element and can achieve the expected objective mentioned above, is of a utility value for the industry and completely conforms to the elements of progressiveness and practicability for the application for a new type patent. According to the law, provided with the document, an application is thus filed. Hopefully your office will grant the patent for this case.

What is claimed is:

1. A “contactless charging device” consists of:
A charger, which is provided with a power line and can provide a charging status' is equipped with all ultrasound oscillator and an emission resonator and on its surface forms a loading area for a battery

2. A battery packet which is a battery pattern with a built-in receiving resonator;
In this way, the charger provides a charging pattern with a power line and its emission resonator can radiate the ultrasound waves of the ultrasound oscillator to the surrounding area of the charger. And place a rechargeable battery packet in the surrounding area of the charger and then the receiving resonator on the battery packet will be caused a resonating effect, i.e., being induced with the powerful magnetic waves in the surrounding area of the charger, and at once the conversion will be into voltage and current, which, through a set of rectifying circuits, are charged into the battery packet after being rectified. Thus the charging process is completed.
